(19) United States
(12) Patent Application Publication
(10) Pub. No.: US 2007/0179974 A1
(43) Pub. Date: Aug. 2, 2007

(54) System and method for integrating policy management into converged prepaid/postpaid telecommunications services

(76) Inventors: Yigang Cai, Naperville, IL (US); Andrew S. Wood, Chippenham (GB); Justin Steven Bayley, Chippenham (GB); Mark Edward Bryant, Bath (GB); Andrew Robert Porter, Swindon (GB)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(21) Appl. No.: 11/343,352

(22) Filed: Jan. 31, 2006

(51) Int. Cl. G06F 17/00

(52) U.S. Cl. 707/104.1

(57) ABSTRACT

A system and method of providing prepaid/postpaid telecommunications services in a telecommunications network using a Rules Editor for provisioning rules for use by a Rules Engine operating as a software process separate from a telecommunications service Application is provided. The Rules can be provisioned in a variety of different manners including by the Service Provider and individual subscribers.

### BACKGROUND OF THE INVENTION

This invention relates to a system and method for integrating policy management into service logic decision rules to enhance existing prepaid/postpaid telecommunication service Applications. While the invention is particularly directed to the art of wireless telecommunications systems, also known as cellular systems, and will be thus described with specific reference thereto, it will be appreciated that the invention may have usefulness in other fields and Applications including wireline telecommunications networks and Internet Protocol Multimedia Subsystems (IMS) networks.

Policy Management is increasingly important in the management of telecommunications networks to provide an ever increasing degree of service for the continually expanding customer base as well as provide improved flexibility in determining how resources are deployed. Much of the existing support for policy in networks has been driven by the need for relatively simple policies that can be enforced in high volume and ultra-short response times.

Conventional prepaid wireless service Applications utilize Decision Graphs based on International Telecommunications Union (ITU) service creation standards to implement Policy Management. However, Decision Graphs typically include complicated table driven logic which cannot be end-user specific, that is to say, defined at the individual subscriber level.

As networks converge and end-user services become more comprehensive, it is important to provide a policy infrastructure that can adapt to these changes. One that operators and even end-users can easily customize and personalize to suite individuals' needs.

Lucent Technologies has developed a policy management project—Rules Engine (RE). The Rules Engine provides fast, scalable, carrier-grade support for specifying and executing policies that are expressive enough to support emerging service Applications as illustrated in U.S. Pat. No. 6,424,948 and U.S. Pat. No. 6,499,023 which are incorporated herein by reference. Both of these patents described the rule workflow systems and the use of computation rules and a combining policy for a powerful and flexible technique for evaluating data items based on the input conditions.

Existing telecommunication services require extremely complicated subscriber account data management and rating systems for prepaid and/or postpaid service Applications. This complexity causes provisioning and performance problems, and it significantly impacts new service creation and enhancements. It is desirable to find a new solution which can provide a greater degree of flexibility in allowing service creation and enhancements to be rolled out rapidly and easily.

The present invention contemplates a new and improved system and method that resolves the above-referenced difficulties and others.

### SUMMARY OF THE INVENTION

A system and method of providing prepaid/postpaid telecommunications services in a telecommunications network using a Rules Editor for provisioning rules for use by a Rules Engine operating as a software process separate from the service Application is provided.

In accordance with one aspect of the invention, the system includes a Rules Editor for creating rules, updating the rules, and distributing rules to network elements, a telecommunications services Application operating as a software process for providing prepaid/postpaid telecommunications services, the Application generating a Rules Engine query at a Decision Point within the Application logic, the Rules Engine query including one or more input Name Value Pairs, and a Rules Engine operating as a separate process separate from the Application for executing rules using the Rules Engine query inputs received from the Application and providing a Rules Engine query output including output Name Value Pairs determined by the outcome of the executed rules, the output Name Value Pairs specifying one or more Actions to be executed by the Application.

In accordance with another aspect of the invention, the method includes creating rules using a Rules Editor, operating a prepaid/postpaid telecommunications services Application as a software process for providing prepaid and/or postpaid telecommunications services, the Application reaching a Decision Point within the Application logic and generating a Rules Engine query including one or more input Name Value Pairs and a ruleset ID, the Application sending the Rules Engine query to a Rules Engine operating as a separate process separate from the Application process, the Rules Engine executing an applicable ruleset as determined by the ruleset ID using the one or more Input Name Value Pairs and generating a Rules Engine query response including one or more output Name Value Pairs specifying one or more actions, and the Application receiving the Rules Engine query response and executing the one or more actions.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system for providing prepaid/postpaid telecommunications services in accordance with the invention;

FIG. 2 is a block diagram illustrating a specific example of the system shown in FIG. 1 for a wireless telecommunications network;

FIG. 3 is a flow chart illustrating the method of operation of the system shown in FIG. 2;

FIG. 4 is a call flow diagram illustrating the operation an example of the system and method shown in FIGS. 3 and 4; and

FIG. 5 is a call flow diagram illustrating the operation an another example of the system and method shown in FIGS. 3 and 4.

### DETAILED DESCRIPTION OF THE PREFERRED EMBODIMENTS

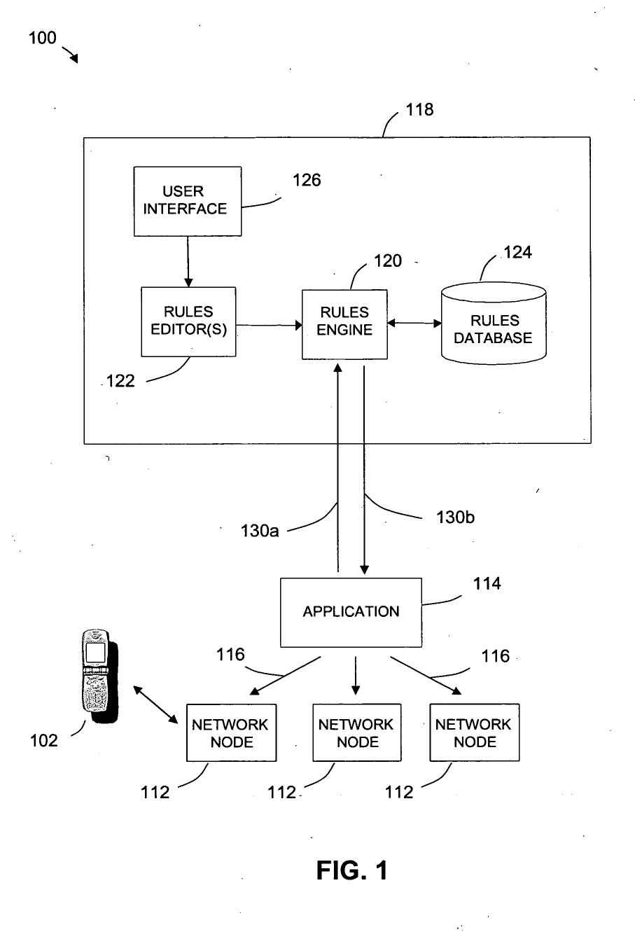

Referring now to the drawings wherein the showings are for purposes of illustrating the preferred embodiments of the invention only and not for purposes of limiting same, FIG. 1 provides a view of the overall preferred system, shown generally at 100, for providing wireless telecommunications services to end-users. The system 100 can be part of a wireless telecommunications network, such as a GSM, CDMA or other known wireless telecommunications networks, having network nodes 112 capable of providing the wireless telecommunications services. Examples of these nodes can include, but are not limited to, Base Stations, Mobile Switching Centers, and Home Location Registers, among others. The system 100 is typically provided and managed by a Service Provider, which may also be referred to as a Network Provider. However, it should be appreciated that the system 100 can also be wireline or IMS network using analogous network elements capable of providing similar telecommunications functions in a wireline or IMS network.

The system 100 includes one or more Applications 114, run on one or more processors (not shown), for directing one or more of the network nodes 112, via actions as shown at 116, to provide appropriate services to the end users via mobile handsets 102, also known as mobile handsets, mobile phones and cellular phones, among others. These actions can also include providing management and maintenance capabilities to the Service Provider, such as for example providing auditing or verification services.

The system 100 also includes a Policy Management Interface (PMI) 118 communicating with the Application 114 for integrating policy management into service logic decision rules which are used by the Application 114 to determine the service needs for all subscribers on an individual basis, and provide them via the actions 116 in real-time, such as for example during call processing. The PMI 118 includes a Rules Engine 120 for processing computational rules provided by one or more Rules Editor(s) 122. The rules can be stored in a Rules Database 124 for access by the Rules Engine 120. One or more User Interfaces 126 can enable end-users, as well as the Service Provider, to create, modify and distribute the rues in an a manner which does not require significant changes to the Application 114 requiring re-compilation, thereby requiring a new Application product release. Though a wireless telecommunications network is used for the purposes of example, it should be appreciated that the invention is also applicable to wireline telecommunications networks and Internet Protocol Multimedia Subsystems (IMS) networks using analogous network nodes.

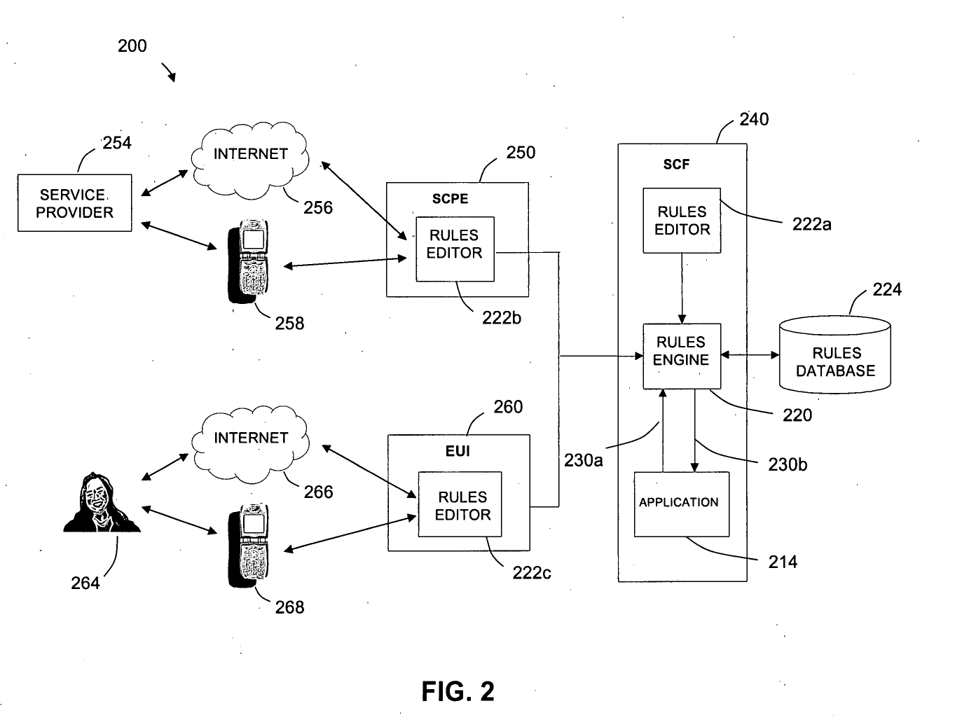

Referring now to FIG. 2, an example of the system 100 is shown at 200 including an Application 214 which provides wireless prepaid services, known as the MiLife™ SurePay product suite from Lucent Technologies. This Prepaid Service Application 214 provides a comprehensive array of Wireless Prepaid services to end-users. End-users typically subscribe to these services, and can therefore be referred to as subscribers, though this term should not be considered limiting as these services may be part of a larger service package or even delivered to end-users without subscription privileges. It should be appreciated that the system 100/200 can also be applicable to postpaid wireless services and wireless network back office billing systems.

The PMI 118 includes a Rules Engine 220 known as Lucent Vortex™, provided by Lucent Technologies. The Lucent Vortex™ Rules Engine is based on the IETF Policy Framework Standards and the Parlay/OSA Policy Management API Standards. The Rules Engine 220 executes one or more rules, referred to as an applicable ruleset, to provide a logic driven outcome resulting in the execution of one or more Actions to provide telecommunications services as shall be described in further detail below.

The Rules Engine 220 can be distributed amongst several functional elements of the wireless telecommunications network and, as such, can be disposed on more than one network node 112, though it should be appreciated that the PMI may be provided by a single network node. The system 200 includes a Service Control Function (SCF) 240 which is responsible for call handling duties in the wireless network. This function 240 can be provided by one or more computational processors which can be included in one or more network nodes 112, such as for example one or more Service Control Points (SCPs).

In this example, the Application 214 and the Rules Engine 220 are provided by the SCF 240. However, it should be appreciated that the Rules Engine 120/220 and the Application 124/224 are separate processes which can be run by different computational processors, also known as servers, computers, or network nodes, among others. Though, alternatively, these separate processes can also be run by the same computational processor. Running the Rules Engine 220 and the Application 214 as separate processes improves the performance of the system 200 by enabling more complex decisions to be made without slowing down the Application. This enables individual end-user-specific rules to be provisioned and executed by the system 100.

The rules database 224 can be disposed on the same processing node as the Rules Engine 220 or on a different processor communicating therewith.

The system 200 includes a plurality of Rules Editors 222 including a Rules Editor 222a closely associated with the Rules Engine 220 as provided by the SCF 240. The system 200 also includes a Service Creation and Provisioning Environment (SCPE) 250 having a Rules Editor 222b enabling the Service Provider 254 to provision the rules by creating rules or modifying existing rules. The SCPE Rules Editor 222b distributes the rules to the Rules Engine 220 for use and/or to the Rules Database 224 for storage. The Service Provider 254 can access the Rules Editor 222b for provisioning the rules via an Internet connection 256, or via a mobile handset 258, or via know network connections.

The system 200 can also include an End User Interface (EUI) 260 having a Rules Editor 222c enabling end-users 264 to provision rules, by creating rules or modifying existing rules, on an individual basis. Thus the rules can be provisioned so as to be subscriber-specific which enables the Application 214 to provide wireless Prepaid services tailored or customized to the specific needs of each individual end-user. The end-users 264 can provision the rules via the Rules Editor 222c using a web-based browser via an Internet connection 266, or via a mobile handset 268. The Rules Editor 222c distributes the provisioned rules to the Rules Engine 220 for use and/or to the Rules Database 224 for storage.

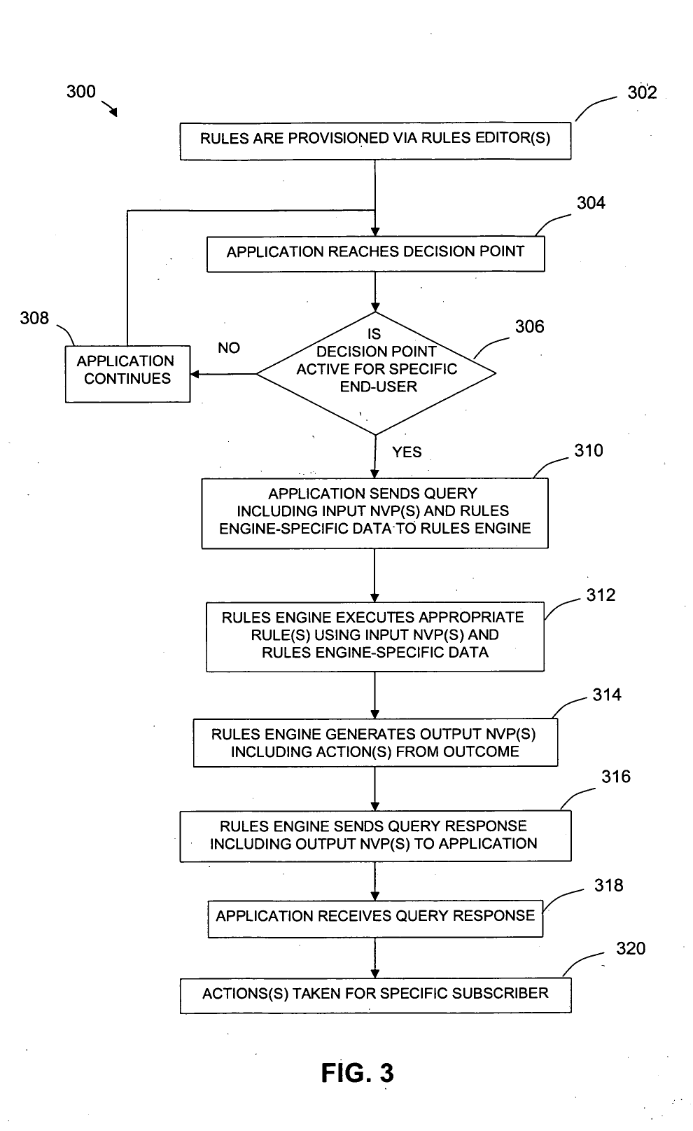

Referring now to FIG. 3, the method of operation of the system 200 shall be described as shown generally at 300. The rules are provisioned via one or more of the Rules Editors 222a-222c at 302. For example, the rules can be created and/or modified by the Service Provider 254 using the Rules Editor 222b and then distributed to the Rules Database 224 for storage. As mentioned, the Service Provider 254 can provision the rules without significant software changes being made to the Prepaid Services Application 214 requiring a new product release.

The Application 214 is running in the SCF 240 and reaches a Decision Point at 304. A wide variety of different Decision Points can be defined via configuration data within the Application 214. Examples, which should not be considered limiting can include Pre-Call Decision Points which are invoked before a call is rated and before it is routed. Pre-Call Decision Points apply to all types of calls, including but not limited to voice calls, and data calls, etc.

A Pre-Routed Call Decision Point which is invoked after the call is rated, but before it is routed. This Decision Point also applies to all types of calls including voice calls, data calls, etc.

Decision Points can also include Pre-Event Decision Points, such as for example a Diameter event charge which is a standard protocol for event/session based charging, or a Lightweight Directory Access Protocol (LDAP) request which is another standard protocol, originally defined as a means to access data from a remote server, but used by the SurePay Application for content charging, such as for example, for charging a sub for a ringtone download. The Pre-Event Decision Points can also include the implementation of real-time SMS services, among others.

Decision Points can also include Post-Call Decision Points that are invoked after call is completed and Post-Event Decision Points that are invoked after an event occurs.

Audit Decision Points are Decision Points that are invoked from an audit process, such as for example, a daily or monthly account audit process.

On Recharge Decision Points are Decision Points that are invoked when a recharge to a prepaid calling plan, also referred to as a top-up, is performed.

Menu Access Decision Points are Decision Points that are invoked by menu access logic, such as via Interactive Voice Response (IVR) systems actuated by the end-user during use. Other Decision Points can include Short Code Decision Points that are invoked by dialing a specific Short Code, such as *64, from a mobile handset.

Decision Points can also be call-specific such as First Call of the Day or First Call of the Month Decision Points that are invoked when the subscriber makes a first call. Activation Decision Points are Decision Points that are invoked when subscriber first activates their account.

The Application 214 uses local configuration data, that is data that does not need to be called from another process, as conditions for determining if the Decision Point is active at 306. For example a Pre-Call decision point will be considered active if the conditions provided by the local configuration data for the prepaid end user are met when the end-user is in the process of making a prepaid call. If the Application 214 determines that the Decision Point is not active at 306, the Application continues on without querying the Rules Engine at 308. If the Application 214 determines that the Decision Point is active at 306, the Application 214 triggers the processing of one or more specific rules, referred to herein as a ruleset, in the Rules Engine 220 by sending one or more Rules Engine queries 230a thereto at 310.

Any individual call, or event, may have zero, one or more decision points active. It is possible for a single call to cause the Application 214 to invoke the Rules Engine 220 to process several different rulesets using multiple Rules Engine queries. Each separate Decision Point can be activated by different configuration data within the Application 214. Different classes of subscribers can be configured with different sets of active decision points. Furthermore, it is possible to flexibly define additional criteria that will be applied in deciding if a Rules Engine query should be triggered or not, such as only query if the user is subscribed to a particular tariff plan or if the subscriber's account balance is greater than some threshold.

The Rules Engine queries are interprocess queries since the Application 214 and the Rules Engine 220 are separate software processes. The Application 214 and the Rules Engine 220 can be local processes running on the same computational processor. Alternatively, they can be remote processes running on different processors such that the Rules Engine queries and responses are transmitted over network connections. Further, the Rules Engine queries can be provided using any suitable known signaling and/or communications protocol, thereby increasing the flexibility of the system 200 for implementation on a variety of different wireless telecommunications networks.

At the active decision points, the Application 214 provides information to the Rules Engine in the Rules Engine query or queries, identifying the one or more rules, referred to as the applicable ruleset, which are to be executed by the Rules Engine using a Ruleset ID.

The Rules Engine queries also include input Name Value Pairs (NVPs) providing data used by the Rules Engine 220 for executing the applicable ruleset. This input NVP data can be configured by the Application 214 to contain any existing Application variable. For example, at an active Pre-Call Decision Point, the Application can send the subscriber identifier, current balance level, tariff plan, and dialed number, among other variables. Thus, any variable defined within the Application logic can be a candidate for an input NVP.

In addition to the ability to flexibly define the input NVP contents to contain any existing Application variable, it is also possible for the Service Provider 254 to define new data that can be passed to the Rules Engine 220 as inputs in the Rules Engine queries, referred to as Rules Engine-specific data. The Rules Engine-specific data can be defined in a variety of different ways to enable the Rules Engine to provide a powerful, flexible and readily provisionable interface to one or more Applications. Examples can include defining the data for individual subscribers, for classes of subscribers, or other types of groupings, or globally. The data can be tariff-related, or it can be applicable to other aspects of the workings of the telecommunications network including call processing.

The Rules Engine-specific data may be defined without any global database schema change, thus allowing the data to be added without re-compiling the Application thus avoiding the need for a new product release of the Application software.

The Rules Engine-specific data can be generated by the Application itself. The ruleset itself can also specify what updates to make to the Rules Engine-specific data. Additionally, the Rules Engine-specific data may be updated by subscribers themselves using the End User Interface (EUI) such as, for example, one in the form of a self-care interface connected via web or WAP.

The Rules Engine 220, upon executing the applicable ruleset at 312, generates output NameNalue pairs (NVPs) at 314 which can specify the execution of one or more Actions implemented on network nodes, shown at 112 in FIG. 1, using known protocols. The output NVPs are included in Rules Engine responses 230b sent by the Rules Engine 220 back to the Application 214 at 316. The Application receives the query response at 318 and the actions are taken for the specific end-user at 320. As mentioned, this all can be done real-time, such as during a call, or during scheduled implementations such as audits, backups, or maintenance related activities, among others.

A wide variety of actions, taken at step 320, can be defined within the Application. Examples, which should not be considered limiting, can include: “Adjust Balance” which applies a debit or credit to the account balance of the subscriber defined in the query input and/or query response; “Transfer Balance” which transfers a balance from one account to another; “Apply Recharge by Credit Card”; “Impose Screening” which determines if the call is allowed to proceed; “Remove Screening”; “Send SMS Notification” which causes an SMS message to be sent (the SMS notification text can be entirely defined by the ruleset or pre-provisioned within the Application); “Send USSD Notification” causing a USSD message to be sent; “Send SMS to 3^{rd} Party” which causes an SMS message to be sent to someone else besides the end-user, for example, to notify a parent that his/her child has made a call to a certain number; “Confiscate Credit” which reduces a subscriber's credit by some amount; “Subscribe to a Promotional Tariff” which enables the subscriber to receive a special tariff, which may for example be at a reduced rate; “Modify Credit Expiry Date” which changes the date when the subscriber's credit is due to expire; “Trigger Change to Subscriber's Lifecycle State causing a change the subs lifecycle state such as from “Recharge Only” to “Active”; “Call Handling” which can be a variety of actions related to how the call is handled by the wireless network, such as for example, barring this call from being connected or routing an incoming call to voice mail. Additionally, the output NVPs may specify that the system 200 should update the contents of certain variables within the Application service logic, including Rules Engine-specific data.

As mentioned, wireless telecommunications service applications have previously deployed Decision Graphs to provide service customization capabilities, based on International Telecommunications Union (ITU) service creation standards. The Rules Engine 220 provides a degree of customization and personalization to the Application 214 that was previously not possible with decision graphs. Decision Graphs cannot be defined at the subscriber level, for example. Further, Decision Graphs cannot create their own data, instead using only variables which are part of the service Application. Also, Decision Graphs are not accessible by the end-user.

However, Rules Engine 220 is not intended as a replacement for decision graphs; rather, it is designed to augment this prior technology and enable network providers to leverage the particular benefits of each. For example, Decision Graphs can interact directly with the end user, such as by playing an announcement or collecting user-entered digits for directing subsequent Decision Graph executions. A Rules Engine ruleset has the ability to execute a Decision Graph using a special Action “Execute Decision Graphs”. Additionally, a Rules Engine query can be triggered from within a DG by using a special Rules Engine SIB (Service Independent Building Block). This combination of technologies provides an a high degree of flexibility and personalization that will enable network providers to deliver enhanced services with extremely rapid time to market.

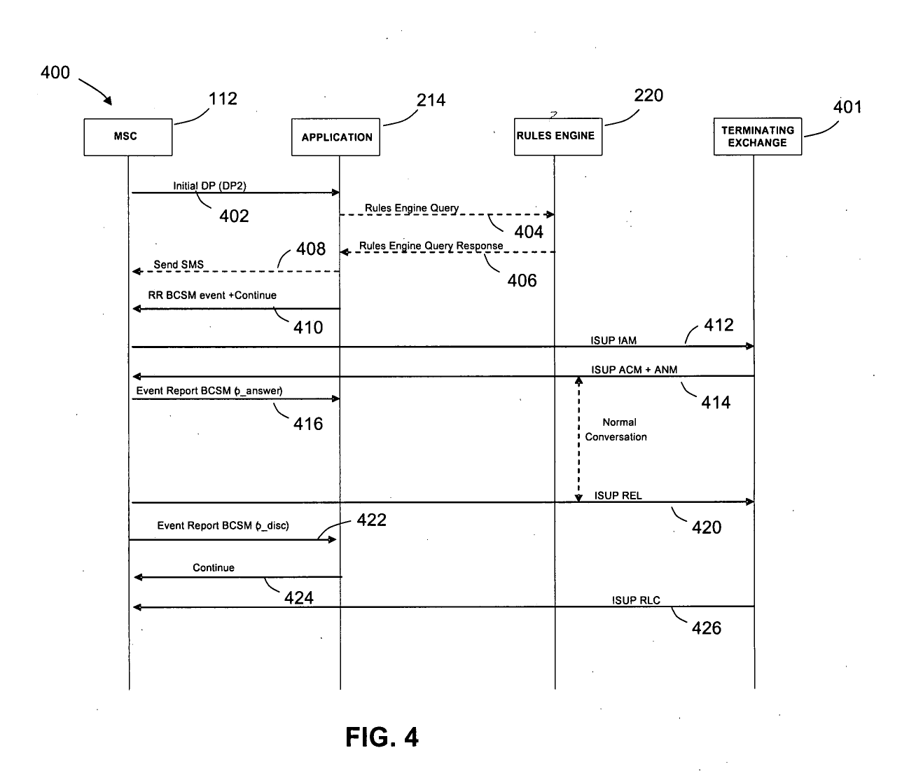

Referring now to FIG. 4, a specific example of the operation of the system 200 is provided as shown by the call flow diagram shown generally at 400. In this example, the Rules Engine 220 is used to define a simple loyalty management scheme whereby a subscriber 264 is rewarded for each year of continual prepaid service with a bonus recharge of prepaid credit. In this scenario, a Pre-Call Decision Point is triggered via a mobile originated call. The protocol used in this example is the European Telecommunications Standard Institute (ETSI) CS1. However, it should be appreciated that this loyalty management scheme can be managed by the system 200 in other ways, such as for example by using an Audit Decision Point and that other known protocols may be used.

An end-user 264 makes a wireless prepaid call to a Terminating Exchange 401. The Terminating Exchange 401 can be a mobile handset or a wireline phone. The serving. MSC 112 sends an InitialDP start event at 402 to the Application 214 for the outgoing call. The Application 214 checks local configuration data and finds that the Pre-Call Decision Point is active for this subscriber.

The Application 214 retrieves the Ruleset ID and input NVP list from configuration data and sends the request in a Rules Engine query at 404. The input NVP data includes the subscriber's first name which is stored in Rules Engine-specific data. Rules Engine 220 receives the Rules Engine query, extracts the input NVPs and begins execution of the specified ruleset. The ruleset execution identifies that the subscriber has been a customer for one year and so qualifies for a bonus.

The Rules Engine 220 sends a Rules Engine query response back to the Application 214 containing output NVPs including Actions to apply a $10 recharge and send an SMS notification to the subscriber's handset 268 to inform the subscriber. The Application 214 receives the query response, applies the $10 bonus and sends the congratulatory SMS notification at 408.

The call setup then continues in a conventional manner. The Application 214 sends Request Report BCSM Event to arm usual events (such as oAnswer, oDisconnect, RouteSelectFail, Busy, oAbandon, NoAnswer) and sends a Continue to MSC at 410. The MSC sends an ISUP Initial Address Message (IAM) 412 to the Terminating exchange. An ISUP Address Complete and Answer are sent to the originating MSC at 414, and at this point, the call is in normal speech phase.

The originating MSC 112 sends an oAnswer event to Application 214 at 416 which begins timing the call at this point for rating purposes. Eventually, the originating party disconnects with ISUP Release to Terminating exchange 401 at 420. The Application 214 is notified with oDisconnect event at 422 and this is the trigger for Application 214 to apply final rating and generate a Call Detail Record. The Application 214 call instance sends Continue to MSC 112 at 424 and terminates. The final ISUP release to deallocate network resources occurs at 426.

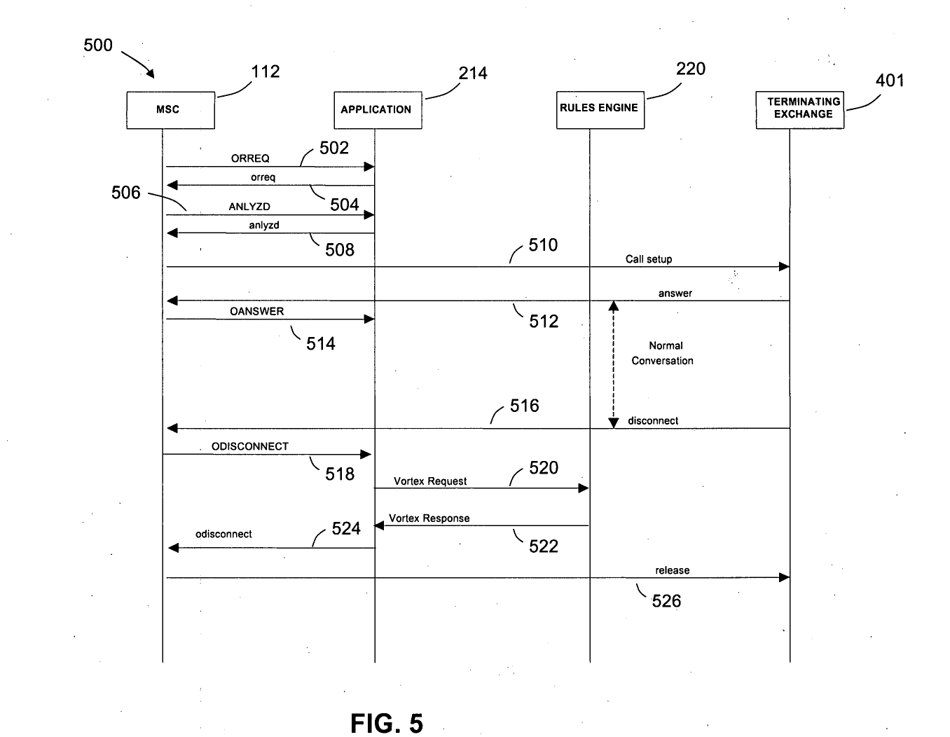

Referring now to FIG. 5 another example of the operation of the system 200 is shown for a call originating from a mobile handset using IS 826 protocol via a Call Flow diagram shown generally at 500. In this example, Rules Engine 240 is used to define a special promotion whereby calls from a certain location are subject to 50% discount, but only if the call cost is greater than $1.00. This example is implemented using a Post Call Decision Point.

The calling party end-user makes a prepaid wireless call to the Terminating Exchange 401 using a mobile handset while at a location which qualifies for the discount. The Serving MSC 112 detects the Origination_Attempt_Authorized (ORREQ) trigger and sends an ORREQ to the SCP 240 associated with this trigger at 502. The SCP 240 includes the MiLife™ SurePay Application 214. The SCP 240 determines that the end-user 264 has Pre Paid Call active indicating that they subscribe to Prepaid call services, and the subscriber's account balance is above the threshold level. The SCP 240 sends an orreq to the Serving MSC 112 at 504 to indicate that call processing shall continue.

The Serving MSC 112 analyzes the dialed digits and prepares to route the call. The Serving MSC 112 detects the Calling_Routing_Address_Available trigger and sends an ANLYZD to the SCP 240 associated with this trigger. The SCP 240 sends an anlyzd to the Serving MSC 112 AT 508. The Serving MSC 112 extends the call at 510 and the call is answered by the called party at 512.

The Serving MSC 112 detects the O_Answer trigger and sends an OANSWER to the SCP 240 associated with this trigger at 514. Upon receipt of the OANSWER, the SCP 240 sets the call start time and begins to time the call. The call is cut through and connected.

When the calling party hangs up, the serving MSC 112 ends the call at 516. The Serving MSC 112 detects the O_Disconnect trigger and sends an ODISCONNECT to the SCP 240 associated with this trigger at 518. Upon receipt of the ODISCONNECT, the SCP 240 calculates the cost of the call. The Application 214 checks local configuration data and finds that the Post-Call Decision Point is active for this subscriber. The call cost is used as an additional criterion to determine if the trigger is active. If the call cost is less than $1 then the Rules Engine 220 is not triggered.

The Application 214 retrieve the Ruleset ID and NVP list from configuration data and sends the request to the Rules Engine 220 at 520. the Rules Engine 220 receives the request, extracts the input NVPs and begins execution of the ruleset specified by the ruleset ID. The ruleset identifies that a special promotion applies to this call based on subscriber's location.

The Rules Engine 220 sends response back to Application 214 containing output NVPs including a “Balance Adjustment” Action to refund 50% of the call cost at 522. The SCP 240 sends an odisconnect to the Serving MSC 112 at 524 and the Serving MSC 112 releases the call at 526.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for providing prepaid/postpaid telecommunications services in a telecommunications network comprising:
a Rules Editor for creating rules, updating the rules, and distributing rules to network elements;
a telecommunications services Application operating as a software process for providing prepaid/postpaid telecommunications services, the Application generating a Rules Engine query at a Decision Point within the Application logic, the Rules Engine query including one or more input Name Value Pairs; and
a Rules Engine operating as a separate process separate from the Application for executing rules using the Rules Engine query inputs received from the Application and providing a Rules Engine query output including output Name Value Pairs determined by the outcome of the executed rules, the output Name Value Pairs specifying one or more Actions to be executed by the Application.

2. The system defined in claim 1 wherein the Application sends the Rules Engine query to the Rules Engine real-time during call processing.

3. The system defined in claim 1 wherein the Rules Editor uploads rules to a Rules Database for storage, the Rules Database being accessible by the Rules Engine for retrieving the rules for execution.

4. The system defined in claim 1 wherein a Service Provider and/or subscriber can provision the rules using the Rules Editor via the Internet and/or via a mobile handset.

5. The system defined in claim 1 wherein the telecommunications network is a wireless telecommunications network.

6. The system defined in claim 1 wherein the telecommunications network is a wireline telecommunications network.

7. The system defined in claim 1 further comprising:
Rules Engine-specific data passed to the Rules Engine as an input for use in executing the ruleset, the Rules Engine-specific data being provided in the system without implementing a global database schema change thereby allowing the data to be added without recompiling the Application software.

8. The system defined in claim 1 wherein the Rules Engine-specific data can be provisioned down to the level of specific individual subscribers.

9. The system defined in claim 1 wherein the Rules Engine-specific data is provided by telecommunications network end-users.

10. A method for providing prepaid/postpaid telecommunications services in a telecommunications network comprising:
creating rules using a Rules Editor
operating a prepaid/postpaid telecommunications services Application as a software process for providing prepaid and/or postpaid telecommunications services;
the Application reaching a Decision Point within the Application logic;
the Application generating a Rules Engine query including one or more input Name Value Pairs and a ruleset ID;
the Application sending the Rules Engine query to a Rules Engine operating as a separate process separate from the Application process;
the Rules Engine receiving the Rules Engine query;
the Rules Engine executing an applicable ruleset as determined by the ruleset ID using the one or more Input Name Value Pairs;
the Rules Engine generating a Rules Engine query response including one or more output Name Value Pairs specifying one or more actions; and
the Application receiving the Rules Engine query response and executing the one or more actions.

11. The method defined in claim 10 further comprising:
defining Rules Engine-specific data without implementing a global database schema change thereby allowing the data to be added without recompiling the Application software; and
Application providing the Rules Engine-specific data to the Rules Engine in the Rules Engine query for executing the ruleset.

12. The method defined in claim 10 wherein the Application sends queries to the Rules Engine during real-time call processing.

13. The method defined in claim 10 wherein the Rules Editor uploads rules to a Rules Database for storage, the Rules Database being accessible by the Rules Engine for retrieving the rules for execution.

14. The method defined in claim 10 wherein Service Provider and/or subscriber can provision the rules using the Rules Editor via the Internet and/or via a mobile handset.

15. The method defined in claim 10 wherein the telecommunications network is a wireless telecommunications network.

16. The method defined in claim 10 wherein the telecommunications network is a wireline telecommunications network.
